(19) United States
(12) Patent Application Publication
(10) Pub. No.: US 2015/0336481 A1
(43) Pub. Date: Nov. 26, 2015

(54) A Base Unit for a Child Restraint

(71) Applicant: Infa-Secure Party Ltd, Emu Plains, AU (US)

(72) Inventor: Richard Munro HORSFALL, Emu Plains (AU)

(21) Appl. No.: 14/411,572

(22) PCT Filed: Dec. 29, 2012
(86) PCT No.: PCT/AU2012/000794

§ 371 Date: Dec. 29, 2014

(51) Int. Cl. B60N 2/28; B60N 2/26

(52) U.S. Cl. CPC B60N 2/2821; B60N 2/265; B60N 2/2887; B60N 2/2875

(57) ABSTRACT

The present invention resides in a child restraint system for a vehicle. The child restraint system comprises a base unit (10) that is configured to be secured to a vehicle seat (5). A seat (30) is also provided. The seat (30) has a seat shell (32) into which a child is to be received and a base (34) upon which the seat shell (32) is supported. The base unit (10) has a receiving portion configured to removably receive the seat (30), the seat (30) being any one of a rearward or forward facing child seat, or any combination of a rearward and forward facing seat. Wherein, the base unit (10) has a substantially upright portion which has connected thereto a first tether (17) attachable to an anchorage point (4) on the vehicle.

### FIELD OF INVENTION

The present invention relates generally to child restraint devices for use in vehicles, and in particular, to a base unit for a child restraint that can be positioned within a vehicle to receive a variety of different types of seating options.

### BACKGROUND ART

The use of child safety seats to accommodate infants and young children whilst travelling in a vehicle is common throughout the world. Most countries have established various laws and regulations that dictate the manner in which infants and children are to be transported in vehicles, and the types of restraints that are acceptable. Most such laws require the infant/child to be restrained in a dedicated and approved child safety seat that is anchored or otherwise secured to a rear seat of the vehicle. The child safety seat may include a dedicated harness that restrains the child in position within the seat, or the child safety seat may utilise the vehicle seat belt or a separate harness to restrain the child therein, depending upon the size and/or age of the child.

As such, there exist a variety of types of child safety seats that are approved for use with children of a variety of ages and/or sizes. These types can be broadly characterised as follows. Type A seats typically refer to rear facing seats or capsules suitable for accommodating babies/infants up to around 12 months of age and/or 80 cm in length and up to 12 kg. Type B seats typically refer to forward facing seats used to accommodate toddlers and young children from approximately 6 months to 4 years, or from 8-18 kg. Type E seats typically refer to booster seats and booster cushions used to accommodate children between 4-8 years old, or approximately from 14-32 kg, and which are typically used in combination with the vehicle seat belt.

To provide a child safety seat that accommodates a child as they grow, combination child safety seats have been proposed, such as type A/B or type B/E seats. In the case of Type A/B seats, such seats are configured so as to be used as both a rearward facing seat and a forward facing seat to accommodate children up to 4 years, or from infancy to 18 kg. In relation to type B/E combination seats, such seats are configured to be used in a forward facing mode to accommodate a children from as young as 6 months to 8 years old, or from 8-32 kg. Hence, whilst some such combination safety seats have been developed for use between different age and weight brackets, during the life of a child there may still be a requirement to purchase at least two different types of seats to accommodate transition between a Type A and a Type E seating arrangement.

In most child safety seats, the seat is secured on the vehicle seat by way of the vehicle seat belt that is passed either around or through the body of the seat. A tether strap or straps may also be employed to restrain an upper portion of the child safety seat in position against a dedicated vehicle anchorage point provided on the chassis of the vehicle. As such, if the child safety seat requires removal from the vehicle, as may be the case if the seat is to be used in another vehicle or if the seat is to be replaced with a different type of child safety seat, a considerable amount of effort is required to remove the seat and replace the seat. Typically, the vehicle seat belt must be repositioned and the various belts tensioned in a manner that requires significant effort, particularly if there is limited space available to perform such tasks, as may be the case where multiple seats are positioned on a vehicle seat.

As such, there is a need to provide a child safety seat system that accommodates a child as the child grows and requires different types of child safety seats. Further, there is a need to provide a child safety seat that makes the act of securing a child within the child safety seat a relatively simple task and which simplifies the act of removal and/or replacement of child safety seats as required with a child's changing seating needs as the child grows.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

Accordingly, in one aspect of the invention there is provided A base unit for a child safety seat comprising a body configured to be received on a seat of a vehicle, the body having a base portion; and a back portion, the base portion adapted to receive a belt system for securing the base portion against the vehicle seat and the back portion having a tether for tethering the back portion to a vehicle anchorage point, wherein the base portion is configured to removably receive a child safety seat thereon.

The tether may be configured so as not to impinge upon the region of the base portion that removably receives the child safety seat thereon so as not to hinder placement and/or removal of the child safety seat.

According to a second aspect, the present invention provides a child restraint system for a vehicle comprising;
a base unit configured to be secured to a vehicle seat; and
a seat, the seat having a seat shell into which a child is to be received and a base upon which the seat shell is supported;
wherein the base unit has a receiving portion configured to removably receive the seat, the seat being any one of a rearward or forward facing child seat, or any combination of a rearward and forward facing seat, and wherein the base unit has a substantially upright portion which has connected thereto a first tether attachable to an anchorage point on the vehicle.

According to an embodiment of the second aspect, the tether is located remote from the receiving portion so as to not substantially impinge upon the receiving portion and hinder placement and/or removal of the seat therefrom. In this regard, the seat may removable from the receiving portion of the base unit without requiring adjustment of the tether.

The base unit may comprise a base portion configured to be received on a surface of the vehicle seat and an upright portion configured to be received against a backrest portion of the vehicle seat. The seat may comprise a connection means for connecting the seat shell to the base unit. There may be a further connection means configured to connect with the upright portion of the base unit.

The seat may further comprise a second tether for tethering to an anchorage point on the vehicle. The second tether may be connectable to the first tether. The first and/or second tether may comprise two parts to facilitate disconnection of the base unit and/or the seat to the anchorage point on the vehicle.

According to a third aspect, there is provided a child restraint system for a vehicle comprising;
a base unit configured to be secured to a vehicle seat; and
a seat unit having a seat shell configured to receive a child therein;
wherein, the base unit is configured to receive the seat unit, and wherein the seat unit is rotatable with respect to the base unit.

The seat unit may comprise a base upon which the seat shell may be supported and wherein the base is mounted to the base unit. The base unit may comprise a releasable locking means for realisably locking the seat unit in at least a forward or a rearward facing mode. The seat unit may be rotatably movable to a sidewards facing mode, located substantially midway between the forward facing mode and the rearward facing mode to facilitate ease of removal of the child from the seat shell of the seat unit.

The base unit may be secured to an anchorage point on the vehicle by way of a tether. The tether may be attached to a substantially upright portion of the base unit. The tether may extend away from the seat unit so as to not substantially hinder movement of the seat with respect to the base unit.

The base unit may be secured with respect to the seat by way of a connection means. In one form, the connection means may comprise a seat belt of the vehicle, wherein the seat belt extends across the base unit. In another form, the connection means may be an ISOFIX or LATCH connection means.

According to another aspect of the present invention, there is provided a base unit for a child safety seat, the base unit being configured to be secured to the vehicle seat and to an anchor point on the vehicle, wherein the base unit is configured to receive a seat assembly, the seat assembly having a seat shell configured to receive a child therein and wherein the seat assembly is free to rotate on the base unit about a central axis to be movable between a forward and a rearward position.

According to yet another aspect of the invention, there is provided a base unit for a child safety seat, the base unit comprising a back portion configured to be secured against a backrest of a vehicle seat, the back portion being secured at an upper region thereof to a vehicle anchorage point by way of a tether and at a lower region to the vehicle seat by way of a connection means, and the back portion having one or more connectors provided thereon to removably engage with a child safety seat.

### BRIEF DESCRIPTION OF THE DRAWINGS

The invention may be better understood from the following non-limiting description of preferred embodiments, in which:

FIG. 1 is a front perspective view of a base unit of a child restraint system according to one embodiment of the present invention;

FIG. 1A is a front perspective view of an alternative embodiment of a base unit of a child restraint system of the present invention

FIG. 2 is a side view of the base unit of FIG. 1;

FIG. 3 is a side view of the base unit of FIG. 1 in use with a Type-A mode child safety seat;

FIG. 4 is a side view of the base unit of FIG. 1 in use with a carry cot;

FIG. 5A is a side view of the base unit of FIG. 1 in use with a Type-B child safety seat;

FIG. 5B is an enlarged view showing the manner in which the Type-B child safety seat of FIG. 5A connects with a back portion of the base unit;

FIG. 6 view of the base unit of FIG. 1 in use with a Type-B child safety seat in accordance with another embodiment;

FIGS. 7A-7C show a child safety in varying rotating positions on a base unit in accordance with an embodiment of the present invention;

FIG. 8A shows a side view of another embodiment of a base unit in accordance with the present invention; and

FIG. 8B shows a side view of yet another embodiment of a base unit in accordance with the present invention.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The present invention will be described below in relation to its application to a Type-A carry cot, Type A rearward facing child safety seat, a Type-B forward facing child safety seat and a Type E booster seat for use in a vehicle. The present invention will be described below in relation to its application for use with a conventional vehicle seat belt, however, it will be appreciated that the present invention could be equally applicable for use with an Isofix or latch system, as may be employed in different vehicle systems.

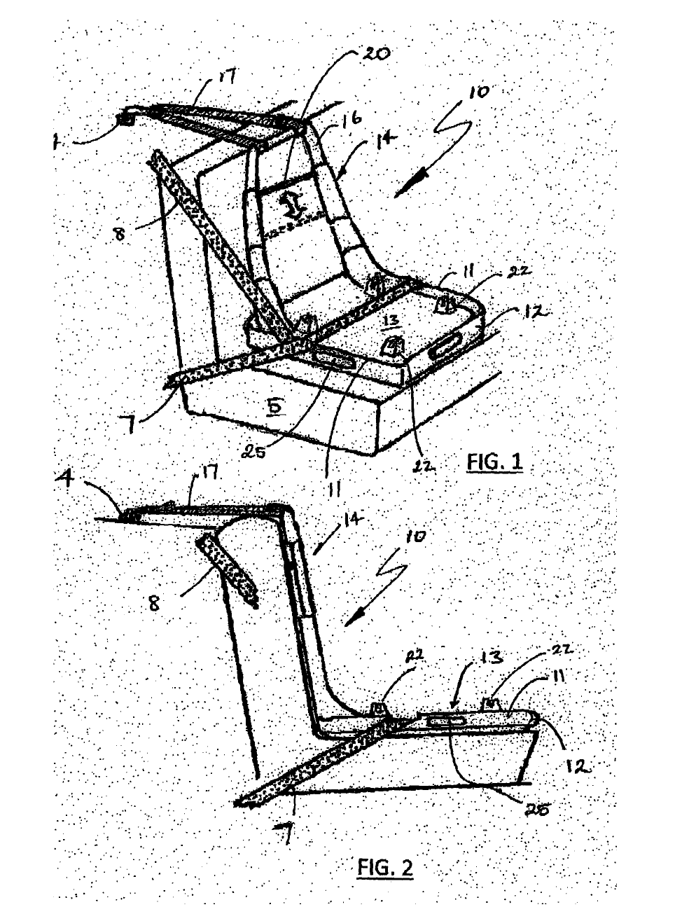

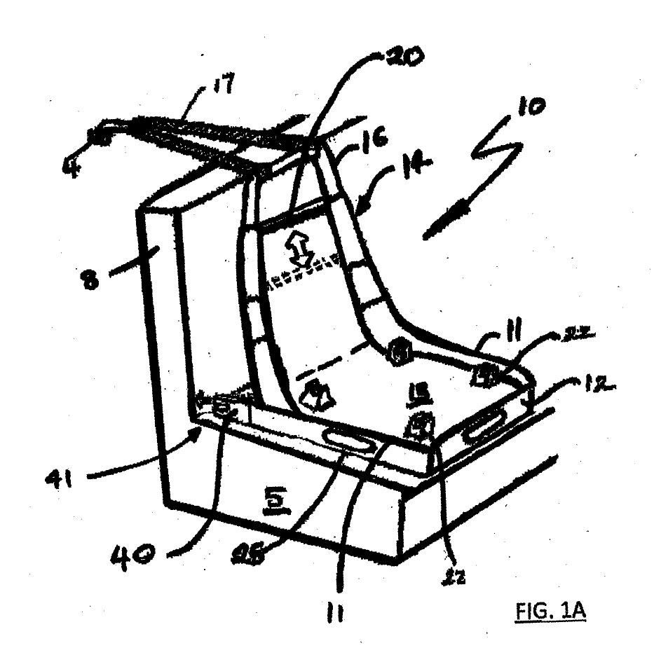

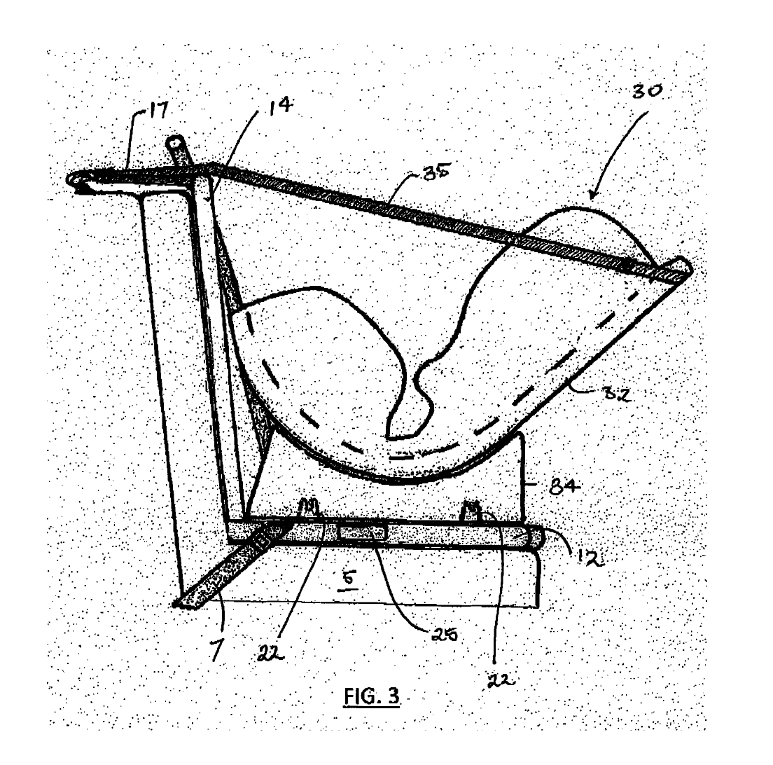

Referring to FIGS. 1 and 2, a base unit 10 according to one embodiment of the child safety seat system of the present invention is shown in isolation. The base unit 10 is shown positioned on a vehicle seat 5, such as a rear seat of a vehicle. The base unit 10 comprises a body having a base portion 12, configured to be supported on a substantially horizontal portion of the vehicle seat 5, and a back portion 14, configured to be positioned against a substantially vertical backrest portion of the vehicle seat 5. The back portion 14 may be pivotally movable with respect to the base portion 12 to accommodate vehicle seats 5 with different angles of reclination.

The base portion 12 is supported on the substantially horizontal portion of the vehicle seat 5. The upper surface 13 of the base portion 12 is substantially planar and represents a receiving portion of the base unit 10 that is configured to receive a child seat thereon, in a manner to be discussed in more detail below. In one embodiment as shown, the base portion 12 may include a raised region 11 that is formed on opposing lateral sides thereof. In such an arrangement, the raised regions 11 may have a recess or cut-away portion 15 formed therein that functions as a guide for receiving and locating the vehicle seat belt 6 as it passes over the upper surface 13 of the base portion 12. As is shown in FIG. 1, both the lap belt portion 7 and the sash portion 8 of the vehicle seat belt 6 are arranged to pass over the upper surface 13 of the base portion 12. However, it will be appreciated that in some instances only the lap belt portion 7 may be employed. It will also be appreciated that the vehicle seat belt/belts may pass through the base portion 12.

In the arrangement as shown in FIG. 1, the vehicle seat belt 6 acts to apply a force against the base portion 12 to secure it against the vehicle seat 5. The force applied by the seat belt 6 against the base portion 12 has a downward component that pushes the base portion against the horizontal portion of the seat 5 as well as a horizontal component that pulls the base portion back against the substantially vertical portion of the seat 5. Thus, the seat belt 6 functions to secure the base portion in position on the seat 5.

Referring to FIG. 1A, an alternative arrangement of a base unit 10 is shown. In this arrangement, the base unit 10 is substantially the same as that shown in FIGS. 1 and 2, and for ease of understanding, the same reference numerals have been used to refer to the same features of the device. However, rather than the base unit 10 being restrained to the seat by way of the vehicle seat belt 6, the base unit employs an alternative latching system. Such a system is known as an ISOFIX securing system. In such a system clamps 40 are provided on the base unit 10 to extend along a rear lower edge thereof. The clamps 40 function to engage with a rod component (not shown) that extends at least partially along the seat of the vehicle in the junction between the backrest portion and the seat portion of the vehicle seat 5. The clamps 40 thus clamp about the rod component to secure the base unit 10 in position on the vehicle seat 5. It will be appreciated that other available securing systems are also envisaged within the present invention, such as a LATCH style system as is commonly used in the USA as well as a LUAS or Canfix system as is commonly used in Canada.

The back portion 14 of the base unit 10 is supported against the backrest of the vehicle seat as shown in FIGS. 1 and 2. In the embodiment as shown, the back portion 14 comprises a tubular frame member 16 that is formed in a U-shape. The ends of the tubular frame member 16 may be mounted to the base portion 12 such that the back portion 14 has a degree of pivotal movement with respect to the base portion 12 to accommodate vehicle seats of varying degrees of inclination. It will be appreciated that the back portion 14 may take a variety of forms that may or may not include a tubular frame member 16 and may be in the form of a substantially planar surface.

A tether 17 is attached to the upper region of the back portion 14. The tether 17 is in the form of a single strap of webbing or a looped strap of webbing having a hook member 18 for attaching via a suitable connection means to a dedicated anchorage point 19 of the vehicle. An adjustment mechanism may be provided to facilitate adjustment of a length of the tether 17 to accommodate vehicles having the anchorage point 19 located at varying distances from the vehicle seat 5. The tether 17 acts to secure the upper portion of the base unit 10 in position against the seat 5. As will be discussed in more detail below, the tether 17 may comprise a connection means (not shown) that facilitates connection of a further tether strap to the anchorage point, as is known in the art. In an alternative arrangement, the tether 17 may be constructed in two parts that are each joined by a connection means so that a first part may remain connected to the anchorage point on the vehicle whilst still allowing the base unit 10 to be removed from the seat. In each of the embodiments of the present invention, the manner in which the tether 17 is constructed and configured to tether the seat to a dedicated vehicle anchorage point can vary and still fall within the spirit of the present invention.

The back portion 14 comprises a support member 20 that extends between opposing sides of the tubular frame member 16. The support member 20 is in the form of a rod that is slidingly repositionable along the back portion 14 so as to adjust the position of the support member 20 to accommodate different shell members, as will be discussed in more detail below.

It will be appreciated that when the base unit 10 is secured in position through the seat belt 6 and the tether 17, the base unit is securely located on the surface of the vehicle seat.

To facilitate use as a child safety seat, the upper surface 13 of the base portion 12 has a plurality of connection members 22 provided thereon. The connection members 22 project from the upper surface 13 to engage with a seat member 30, as will be discussed in more detail below. In the embodiment as shown, four connection members 22 are located on the upper surface 13 of the base portion 12, two connection members at the rear of the upper surface 13 and two connection members at the front of the upper surface 13. It will be appreciated that the actual number and location of the connection members 22 may vary as required. The connection members 22 may be formed integral with the base portion 12, or may be separately attached to the base portion 12. It will be appreciated that, whilst specific examples of means for attaching the seat member 30 to the base unit are shown in the present invention, the means may take a variety of differing forms and still fall within the spirit of the present invention.

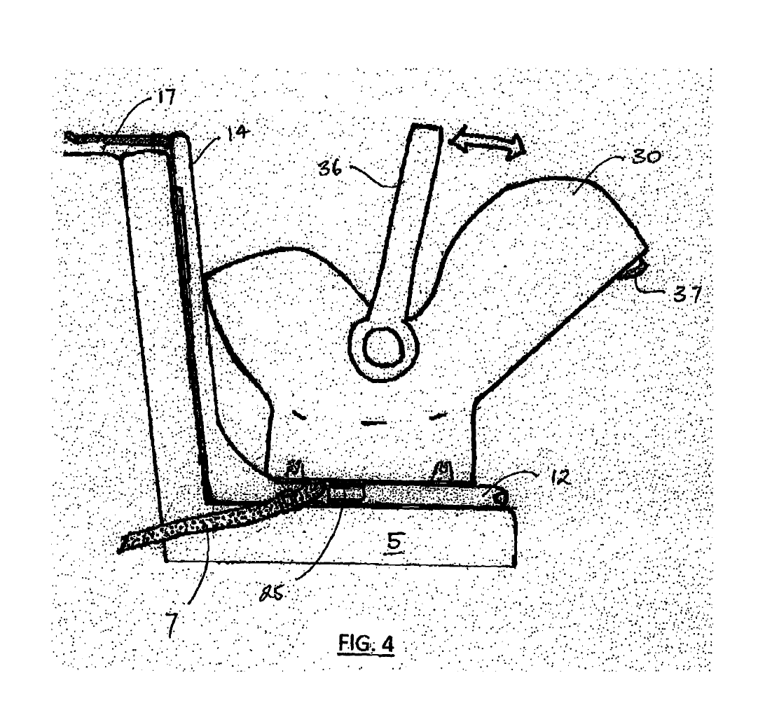

Referring to FIG. 3, an embodiment of the base unit 10 being used in a Type-A, rearward facing child safety seat mode is shown. In this arrangement a seat 30 comprising a shell 32 supported on a base 34 is positioned on the upper surface 13 of the base unit 10. The shell 32 is configured to be movably mounted on base 34 to facilitate adjustment of the angle of inclination of the shell 32 with respect to the base 34.

The base 34 is mounted to the base portion 12 of the base unit 10 by way of the connection members 22. As discussed above, the connection members 22 typically project beyond the upper surface 13 of the base portion and have a recess 23 formed therein. The recess 23 provides an opening into which is received a complementary projection (not shown) formed in the underside of the base 34 of the seat 30. When the base 34 of the seat 30 is positioned in the base portion 12 of the base unit 10, the projection is received within the recess 23 this forming an engagement between the base unit 10 and the seat 30. To lock the seat 30 in position, the base unit 10 may have an engagement/disengagement mechanism 25. In the embodiment as shown the engagement/disengagement mechanism 25 is located on a side wall of the base portion 12, however, the engagement/disengagement mechanism 25 may be located in a variety of positions on the base unit 10, or alternatively, on the seat 30.

It will be appreciated that by activating/deactivating the mechanism 25 the seat 30 can be secured/released from the base unit 10. In the embodiment as shown, upon engaging the mechanism 25 the recess 23 may be caused to close around the projection provided on the underside of the base 34 thus causing the base 34 to become engaged with the base unit 10. Other means for facilitating connection/disconnection between the seat 30 and the base unit 10 are also envisaged.

In the embodiment as shown in FIG. 3, the shell 32 may comprise a second tether strap 35 for restraining movement of the shell 32 of the seat 30 during use. In such an arrangement, the tether strap 35 may extend to the anchorage point 4 located on the vehicle and may connect either directly to the anchorage point or may connect to a connection means carried by the first tether 17 of the base unit 10.

It will be appreciated that in the arrangement as shown in FIG. 3, the seat 30 can be readily secured to the pre-positioned base unit 10 by merely bringing the seat 30 into contact with the base unit 10 such that the connection members 22 engage with an underside of the base 34 of the seat 30. The tether strap 35 can then be simply connected either directly or indirectly to the anchorage point 4 and tightened for use. Similarly, in order to remove the seat 30 from the vehicle, the engagement/disengagement mechanism 25 can be merely activated to disengage connection between the base 34 of the seat 30 and the base portion 12 of the base unit 10. The tether strap 35 can then be simply disengaged from the anchorage location and the seat removed for use in another vehicle as desired. There is no requirement for disengaging the base unit 10 and releasing the seat belt 6 each time the seat 30 is fitted/removed. In this regard, the tether strap 35 may also be so configured in two connectable portions, to aid in disconnection of the tether strap 35 without having to disengage the end of the tether strap 35 from the vehicle anchorage point, to facilitate ease of removal of the seat 30.

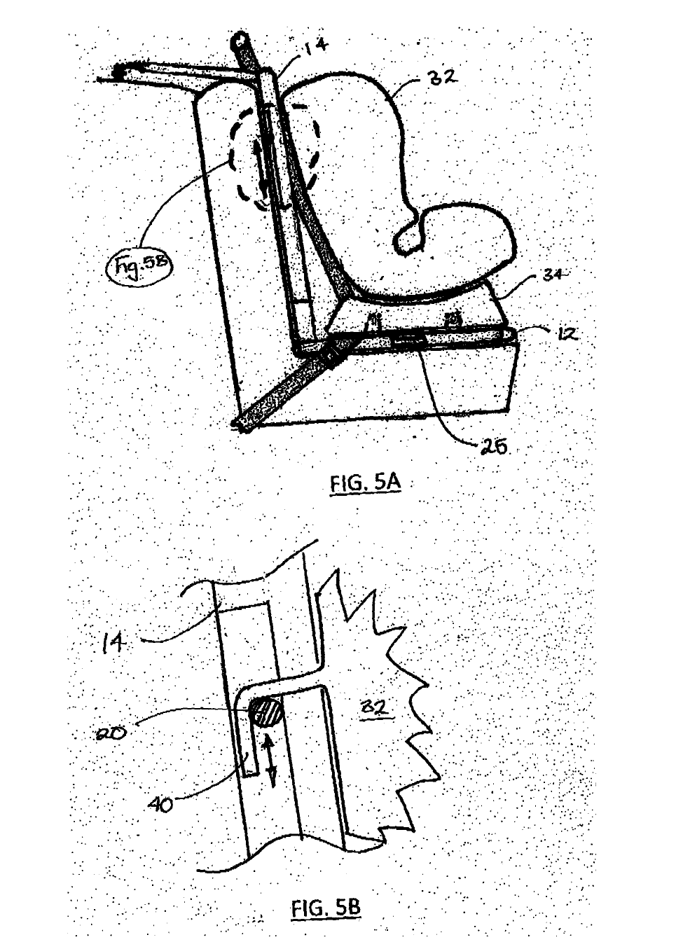

Referring to FIG. 4, there is shown a safety seat 30 of the Type-A mode, whereby the seat 30 is in the form of a removable carry cot. In this arrangement the child is contained in the carry cot and is able to be lifted and transported to/from the vehicle by way of handle 36, which is pivotally connected to the seat 30 as depicted by the arrow.

The carry cot 30 is positioned on the base portion 12 of the base unit 10, in the manner as shown in FIG. 4. When positioned in such a manner, the connection members 22 engage with projections (not shown) provided on the base of the carry cot 30 to securely retain the carry cot 30 in position on the base portion 12 of the base unit 10. Engagement/disengagement mechanism 25 may be employed to lock/unlock the carry cot 30 in position. A release lever 37 may also, or alternatively, be provided on the carry cot 30 to facilitate release of the engagement members when the carry cot is to be removed from the base unit 10.

As will be appreciated, when the system is used in the manner as shown in FIG. 4, there is no requirement to employ a tether strap to secure the top of the carry cot to the vehicle anchorage point as the base unit 10 is already secured to the vehicle anchorage point 4 via tether 17. Hence the carry cot can be simply fitted and removed without the need for the user to fit complicated tethering arrangements around the carry cot 30.

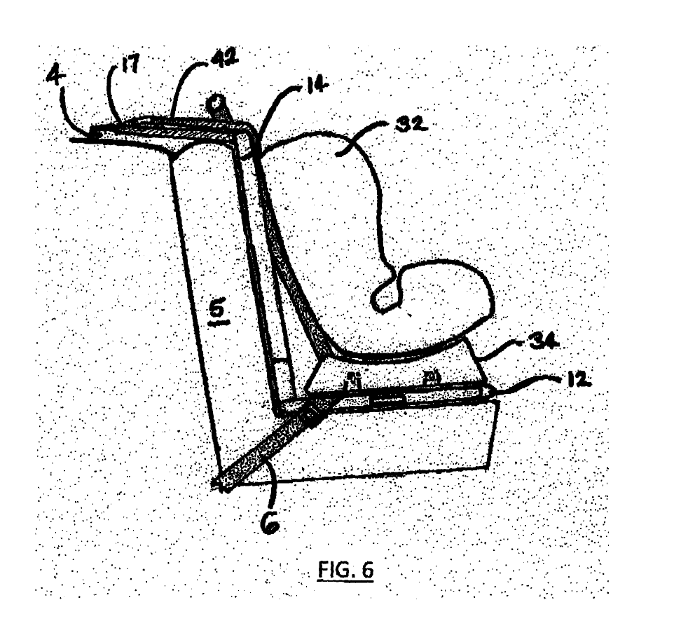

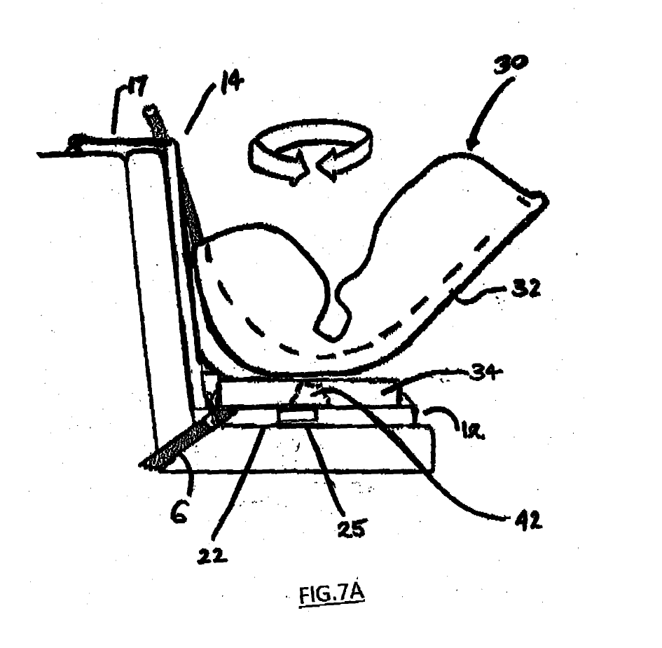

Referring to FIG. 5A, there is shown a forward facing Type-B mode child safety seat 30. As with the embodiments described above, the base unit 10 is secured on the vehicle seat 5 by way of the vehicle seat belt 6 and a tether 17. The seat 30 comprises a shell 32 mounted on a base 34. The shell 32 may be mounted on the base 34 to facilitate adjustment of the angle of reclination of the shell 32 with respect to the base 34.

To secure the seat 30 to the base unit 10, the base 34 of the seat is positioned on the base portion of the base unit, as shown such that the connection members 22 engage with projections (not shown) provided on the underside of the base 34. The engagement/disengagement mechanism 25 can then be activated to engage the base 34 in position on the base portion 12 of the base unit 10.

The seat 30 is also connected to the back portion 14 of the base unit 10 in the manner as depicted in FIG. 5B. In this arrangement, the rear of the shell 32 of the seat 30 is provided with a connector 40 that connects about the support member 20 provided in the back portion 14. In the embodiment as shown the connector 40 is in the form of a projection that extends from the rear surface of the back portion 14 so as to engage with the support member 20 in the manner as shown. As the connector 40 is configured to extend over and behind the support member 20, any forward movement of the shell 20, as may be experienced in the event of sudden breaking of the vehicle or a vehicle accident, will be resisted. It will be appreciated that the connector 40 may take a variety of forms and the manner in which the connector 40 engages with the support member 20 may also vary and still fall within the spirit of the present invention.

As previously discussed, the support member 20 is slidingly movable along the back portion 14 of the base unit 10. Such adjustment of the position of the support member facilitates seats 30 with various angles of inclination, as may be desirable by the user of the seat 30.

It will be appreciated that the seat 30 as shown in FIGS. 5A and 5B is connected to the base unit 10 at both the base portion 12 and the back portion 14. Such an arrangement is achieved by merely placing the seat 30 on the base portion 10 and activating the connection members 22 to engage with the underside of the base 34 of the seat 30. Hence, there is no requirement for a need to install additional tether straps or seat belts as has traditionally been the case with existing Type-B child safety seats.

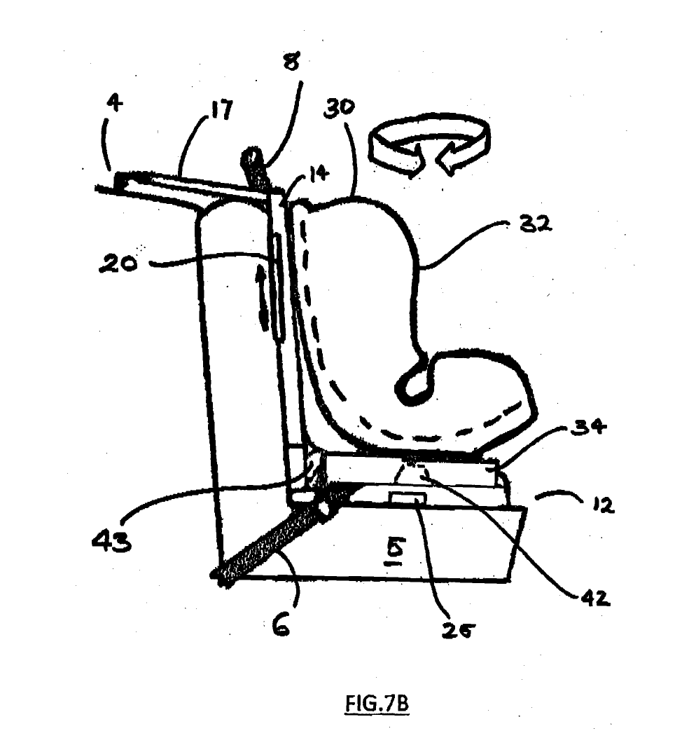

A variation of the arrangement shown in FIG. 5A is shown in FIG. 6. In this arrangement, there is shown a Type-B child safety seat 30 where the seat 30 is mounted to the base unit 10 in substantially the same manner as described above in relation to FIG. 5A. However, rather than the seat 30 being connected to the back portion 14 of the base unit 10, the seat shell 32 employs a tether, strap 42 that connects to the anchorage point 4 of the vehicle. As the tether 17 of the base unit 10 is connected to the anchorage point 4 of the vehicle, a hook of the tether strap 42 may connect directly to the hook of the tether 17, or to a connection means attached to the tether 17, such that both the tether 17 and the tether strap 42 connect to the same vehicle anchorage point 4.

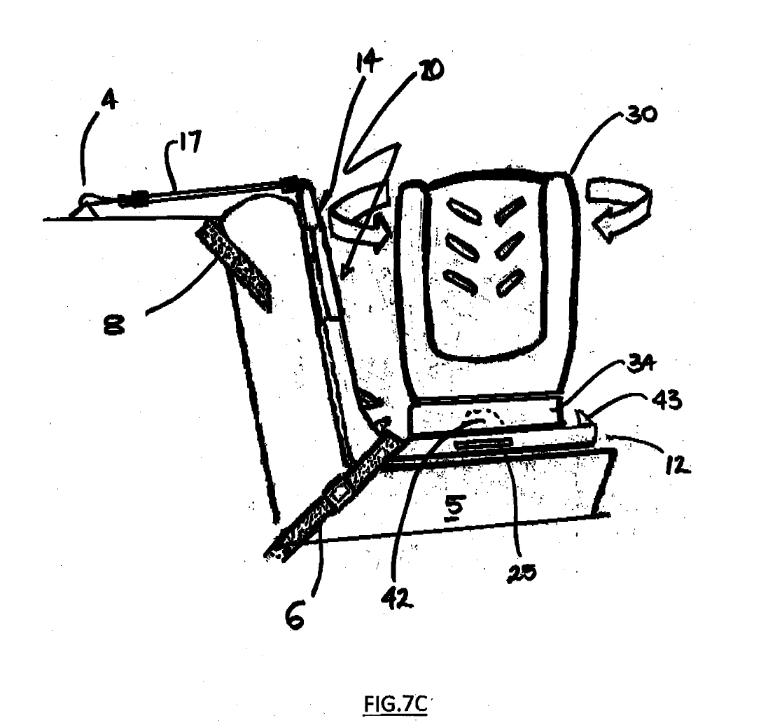

Yet another variation of a child safety seat 30 is shown in FIGS. 7A-7C. In this arrangement, the seat 30 comprises a seat shell, 32 that is mounted on a base 34; The base 34 of the seat 30 is mounted to the base unit 10 at a central point 42 such that the shell 32 and base 34 are able to rotate about the central point 42 with respect to the base unit 10. Such an arrangement allows the seat 30 to be used as a rearward facing type-A child safety seat, as is shown in FIG. 7A or a forward facing type-B child safety seat, as is shown in FIG. 7B.

The seat 30 is preferably lockable in position when in either the forward facing or rearward facing mode. A secondary locking means may be provided on the backrest portion of the base unit 10 to engage with the seat 30 to further support and retain the seat in the desired rotationary position. To accommodate ss variations in inclination of the seat shell 32, the secondary locking means may be movable along the surface of the backrest portion of the base unit 10.

In such a rotational arrangement as shown in the embodiment of the child safety seat of FIGS. 7A-7C, the seat 30 may be rotated to a side position as shown in FIG. 7C. When in the side facing position of FIG. 7C, the child may easily be removed from the seat and vehicle without having to lift and carry the child over the sides of the child safety seat. In such a position, the seat belt 6 can also be more easily fitted to extend across the base unit 10, thus proving a simpler arrangement for installing the child safety seat in position.

In the embodiment as shown in FIGS. 7A-7C, the manner in which the seat shell 32 and base 34 attach to the base unit 10 may vary. In this regard, rather than supplying a central point 42 of connection, the base 12 of the base unit 10 may employ a turntable arrangement which facilitates rotational movement and the base 34 of the seat 30 may be held in position on the base 12 of the base unit 10 by connection members 43 provided at the periphery of the base 12.

In each of the embodiments described above, the seat shell 32 and the base 34 may be releasably connected to the base unit 10 to facilitate removal of the seat 30 without removing the base unit 10. Similarly, whilst the base unit is shown as being secured in position by way of a seat belt 6, other securement means, such as an ISOFIX or LATCH system are also envisaged.

In each of the embodiments described above, the base unit 10 can accommodate a variety of different types of seats 30, without requiring removal or significant adjustment. In this regard, the base unit 10 can be positioned for use on the seat 5 of the vehicle and secured in place by way of the vehicle seat belt 6 and a tether 17. Once positioned and secured in place, the base unit 10 can remain in position as the child grows to accommodate a variety of different seat modes.

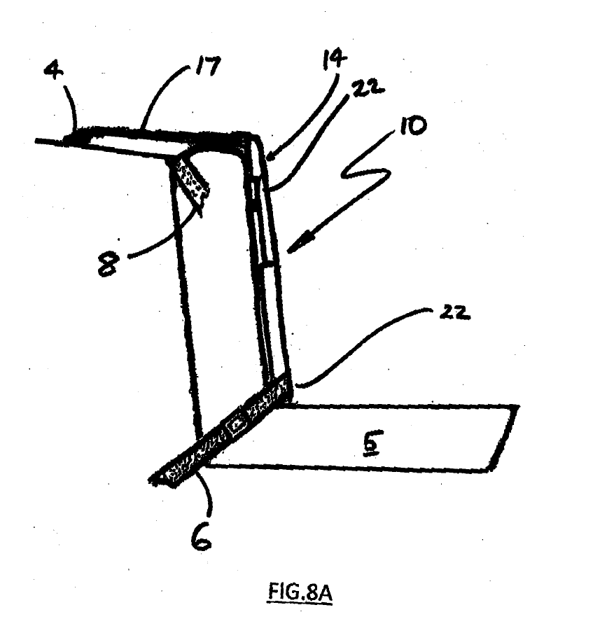

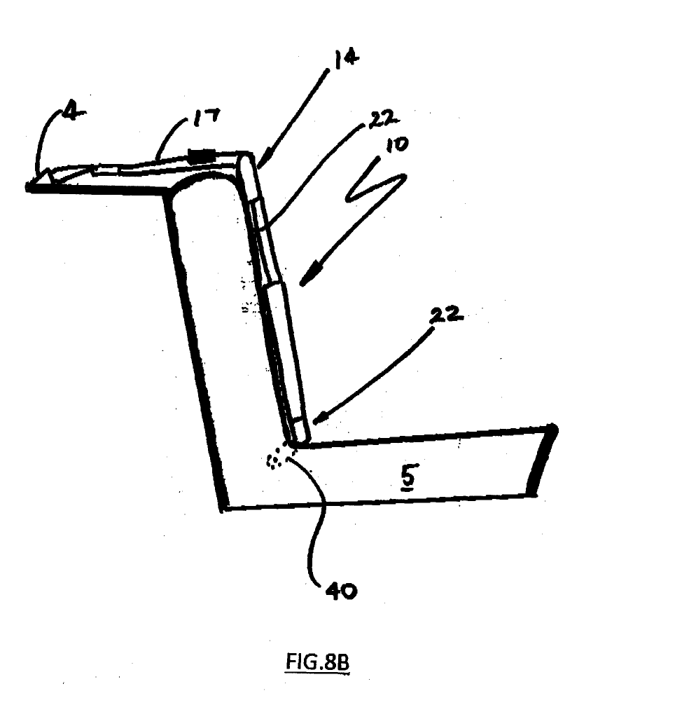

Another embodiment of a base unit 10 is shown in FIGS. 8A and 8B. In FIG. 8A the base unit 10 comprises a backrest portion 14 only so as to be positioned on a vehicle seat 5 such that the backrest portion 14 is received against the backrest of the vehicle seat 5. When positioned in such a manner, the base unit 10 is secured in position at a top or upper region by way of a tether 17 that attaches to a dedicated vehicle anchorage point 4 located behind the vehicle seat 5. The lower region of the base unit 10 is secured against the backrest of the vehicle seat 5 by way of the vehicle seat belt 6. In such an arrangement, the base unit 10 is securely positioned against the backrest of the vehicle seat at both an upper and lower region, so as to be securely retained in position during use.

In order to receive a child safety seat, the backrest portion 14 of the base unit 10 has one or more connectors (not shown) formed thereon. The connectors are preferably adjustable in position and function to engage with a body of the child safety seat positioned against the backrest portion 14 thereof. It will be appreciated that the child safety seat is supported on the vehicle seat 5 by a base portion thereof in a conventional manner, with the body of the child safety seat being secured to the backrest portion 14 of the base unit 10.

A variation of the embodiment of the base unit 10 of FIG. 8A is shown in FIG. 8B. In this embodiment, the base unit 10 also comprises only the backrest portion 14 which is secured at an upper region thereof by way of a tether 17. The tether 17 is in turn secured to the dedicated anchorage point 4 provided on the vehicle, as is well understood in the art.

However, the base unit 10 of FIG. 8B is secured at a lower region to the vehicle through an ISOFIX or LATCH style system 40, or any other similar system, such as the LUAS or Canfix system.

As previously discussed, in each of the above described embodiments, the vehicle seat belt 6 may be replaced by an alternative securement system as is understood in the art. In this regard, rather than a vehicle seat belt to secure the seating system, a European-type ISOFIX system may be employed or a LATCH style system as is commonly used in the USA as well as a LUAS or Canfix system as is commonly used in Canada.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the child safety seat uppermost.

The claims defining the invention are as follows:

1. A child restraint system for a vehicle comprising:
a base unit configured to be secured to a vehicle seat; and
a seat, the seat having a seat shell into which a child is to be received and a base upon which the seat shell is supported;
wherein the base unit has a receiving portion configured to removably receive the seat, the seat being any one of a rearward or forward facing child seat, or any combination of a rearward and forward facing seat, and wherein the base unit has a substantially upright portion which has connected thereto a first tether attachable to an anchorage point on the vehicle.

2. A child restraint system according to claim 1, wherein the tether is located remote from the receiving portion so as to not substantially impinge upon the receiving portion and hinder placement and/or removal of the seat therefrom.

3. A child restraint system according to claim 2, wherein the seat is removable from the receiving portion of the base built without requiring adjustment of the tether.

4. A child restraint system according to claim 1, wherein the base unit comprises a base portion configured to be received on a surface of the vehicle seat and the substantially upright portion is configured to be received against a backrest portion of the vehicle seat.

5. A child restraint system according to claim 4, wherein the seat comprises a connection means for connecting the seat shell to the base unit.

6. A child safety seat according to claim 5, wherein the connection means is configured to connect with the upright portion of the base unit.

7. A child safety seat according to claim 1, wherein the seat further comprises a second tether for tethering to an anchorage point on the vehicle.

8. A child safety seat according to claim 7, wherein the second tether is connectable to the first tether.

9. A child safety seat according to claim 7, wherein the first and/or second tether comprises two parts to facilitate disconnection of the base unit and/or the seat to the anchorage point on the vehicle.

10. A child restraint system for a vehicle comprising;
a base unit configured to be secured to a vehicle seat; and
a seat unit having a seat shell configured to receive a child therein;
wherein, the base unit is configured to receive the seat unit, and wherein the seat unit is rotatable with respect to the base unit.

11. A child restraint system according to claim 10, wherein the seat unit comprises a base upon which the seat shell is supported and wherein the base is mounted to the base unit.

12. A child restraint system according to claim 11, wherein the base unit comprises a releasable locking means for realisably locking the seat unit in at least a forward or a rearward facing mode.

13. A child restraint system according to claim 12, wherein the seat unit is rotatably movable to a sidewards facing mode, located substantially midway between the forward facing mode and the rearward facing mode to facilitate ease of removal of the child from the seat shell of the seat unit.

14. A child restraint system according to any one of claims 10-13, wherein the base unit is secured to an anchorage point on the vehicle by way of a tether.

15. A child restraint system according to claim 14, wherein the tether is attached to a substantially upright portion of the base unit.

16. A child restraint system according to claim 15, wherein the tether extends away from the seat unit so as to not substantially hinder movement of the seat unit with respect to the base unit.

17. A child restraint system according to any one of claims 10-16, wherein the base unit is secured with respect to the vehicle seat by way of a connection means.

18. A child restraint system according to claim 17, wherein the connection means comprises a seat belt of the vehicle, wherein the seat belt extends across or through the base unit.

19. A child restraint system according to claim 17, wherein the connection means is an ISOFIX or LATCH connection means.

20. A child restraint system according to either claim 11, wherein the seat shell is reclinable with respect to the base.

21. A child restraint system according to claim 10, wherein the base unit comprises a unitary member configured to be secured against a backrest of the vehicle seat, the unitary member being secured at a lower end by way of a connection means and at an upper end by way of a tether to a vehicle anchorage point.

22. A base unit for a child safety seat comprising a body configured to be received on a seat of a vehicle, the body having a base portion; and a back portion, the base portion adapted to receive a securement system for securing the base portion against the vehicle seat and the back portion having a tether for tethering a region of the back portion adjacent a backrest of the vehicle seat to a vehicle anchorage point, wherein the base portion is configured to removably receive a child safety seat thereon.
